(19) United States
(12) Patent Application Publication
(10) Pub. No.: US 2004/0216232 A1
(43) Pub. Date: Nov. 4, 2004

(54) Attachment mechanism for medical table

(75) Inventor: James M. Bradcovich, Cuyahoga Falls, OH (US)

Correspondence Address: BROUSE MCDOWELL, INTELLECTUAL PROPERTY GROUP, 500 FIRST NATIONAL TOWER, AKRON, OH, 44308, US

(73) Assignee: Bradko Medical Corporation

(21) Appl. No.: 10/427,546

(22) Filed: May 1, 2003

(51) Int. Cl. A61G 13/12; A61G 13/00

(52) U.S. Cl. 5/601; 5/623; 378/209

(57) ABSTRACT

A medical table top is formed with a connecting portion formed about the periphery of the table top. An extension accessory is provided that includes a receiving portion that snap fits over the connecting portion of the medical table top. The material from which the medical table top and accessory extension is constructed does not absorb energy rays, such as X-rays and does not interfere with the examining procedure involving X-rays.

### I. BACKGROUND OF THE INVENTION

A. Field of Invention

This invention pertains to the art of methods and apparatuses of medical procedural and surgery tables and more specifically to attachments for a medical procedural or surgery table top.

B. Description of the Related Art

In the medical field it is known for medical practitioners to utilize tables for various medical procedures. In one application, imaging tables are used scan the interior of the human body for any number of medical conditions. One such application may include X-raying a patient for diagnosis of a physical or medical condition. It is also known in the medical arts to place a patient on a stationary table and maneuver an imaging device around the patient. Yet, certain examining energy rays, such as X-rays, may be blocked, that is to say absorbed, by the table itself.

In the medical art it is also known to utilize medical equipment or accessories on or about the procedural tables. This may include catheters, surgical equipment and the like. Such equipment is needed in close proximity to the patient and the region of the body being examined or treated. For example, someone's arm may need extended to insert an IV. It would be advantageous to have an extension suited for supporting the person arm while the IV is being inserted. Alternately, an extension may be useful in checking for shoulder movement during diagnosis while the patient is positioned on the examining table.

Therefore an apparatus and method for extending accessories of various types is needed for use with medical procedural and surgical table tops that can be conveniently and quickly placed into and removed from various positions. It is also advantageous having accessory extensions that do not affect examining energy rays. The subject invention obviates the aforementioned difficulties.

### II. SUMMARY OF THE INVENTION

According to one aspect of the present invention, a new and improved medical table top is provided that does not appreciably absorb X-rays during an X-ray examining procedure.

Another aspect of the present invention includes a medical table top extension member that is selectively infinitely positionable along the peripheral edge of the medical table top.

Yet another aspect of the present invention includes an accessory extension that snap fits onto the medical table top.

Still another aspect of the present invention includes a medical table top that has a connecting portion fashioned about the periphery of the medical table top.

Another aspect of the present invention includes a medical table top extension member that does not significantly absorb medical examining energy rays during the examination process.

A medical table is provided for varied medical procedures that includes a table top portion. The table top may be a procedural table top or a surgical table top or any table top used for medical purposes. The medical table top includes a connecting portion formed about the entire periphery of the circumference of the medical table top. One or more accessory extension may be interlocked onto the connecting portion of the medical table top. An operator may select an appropriate location along the periphery of the medical table top and snap fit the one or more accessory extension in place. Once in place the accessory extension does not interfere with medical examining rays, such as X-rays, in that is constructed from materials that do not absorb the medical examining energy rays.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is an isometric view of a medical procedural table with an energy ray imaging device.

FIG. 2a is an isometric view of a medical procedural/surgical table with medical accessory extension attached thereto.

FIG. 2b is a cross-sectional view a medical procedural/surgical table with medical accessory extension attached thereto.

FIG. 3 is a close up cross-sectional view of the medical accessory extension interlocked to the medical procedural/surgical table.

### IV. DESCRIPTION OF THE PREFERRED EMBODIMENT

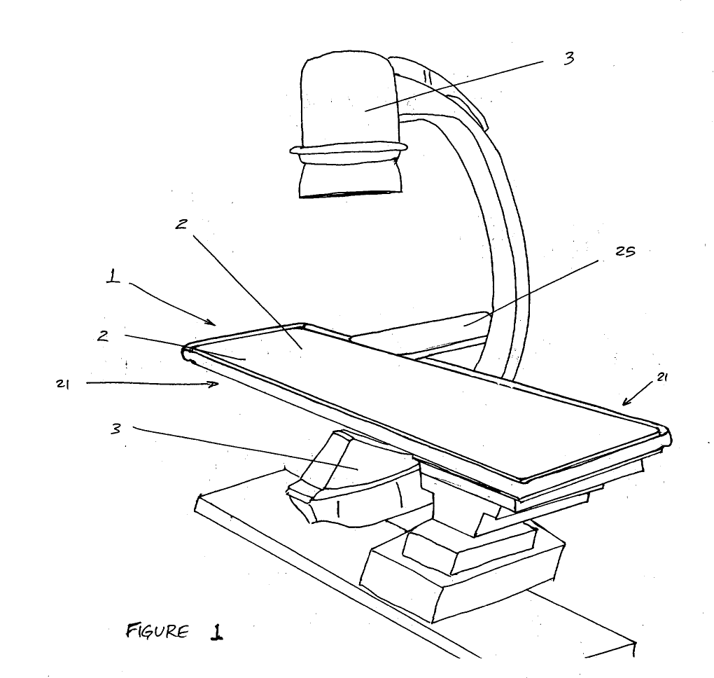

Referring now to the drawings wherein the showings are for purposes of illustrating a preferred embodiment of the invention only and not for purposes of limiting the same, FIG. 1 depicts a medical procedural table shown generally at 1. The medical procedural table 1 or medical table 1 may support a patient, not shown, for use with various medical examining or treatment procedures. It is understood for the subject invention that the medical table 1 may be used for any medical purpose including but not limited to surgery, minimally invasive surgical procedure, diagnoses of medical conditions, treatment of medical conditions, X-raying and the like. FIG. 1 depicts one application of the medical table 1 used with an energy ray imaging device 3, which may be an X-ray machine 3. The energy ray imaging device 3 may be maneuvered about the medical table 1. In this manner, when a patient is placed on the medical table 1 the imaging device 3 may be translated through various axes of movement taking images of the patient at various places and angles without having to move the patient. Since the medical table 1 may at times reside between the imaging device 3 and the patient, the medical table 1 may be constructed from materials that do not block or absorb the energy examining rays, thus allowing the rays to pass through the table and into the body. This is important because if the medical table 1 absorbed a significant part or all of the energy rays, higher power energy rays may have to be used to obtain an accurate image of the patient's body, which may result in damage of the patient's tissue due to the higher energy power level of the rays. That is to say that higher power energy rays would have to be used to overcome the absorption of rays by the table.

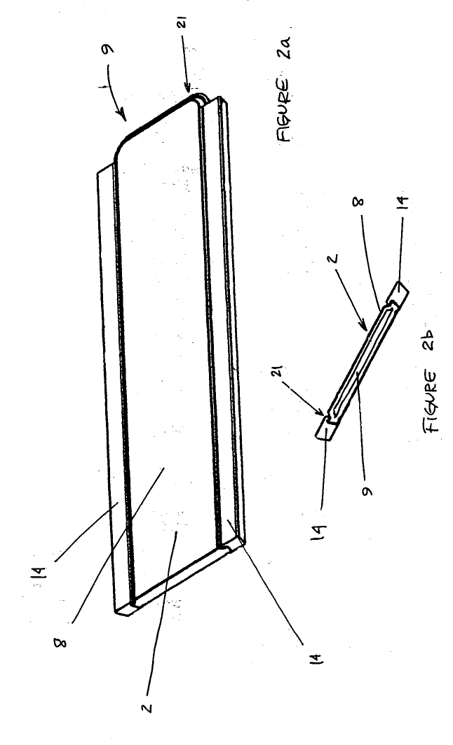

With continued reference to FIG. 1 and now to FIGS. 2a and 2b, a medical table top 2 is depicted apart from the medical table 1 in FIGS. 2a and 2b and separate from a specific medical use. It is noted that the medical table top 2 may include accessory extensions, which will be discussed in subsequent paragraph. The medical table top 2 or medical procedural table top 2 has a characteristic length L, width W and thickness T. The dimensions of the length, width and thickness may be chosen with sound judgment as is appropriate for use in supporting a patient as described above. In one embodiment, the medical table top 2 is generally rectangular. However, any geometric configuration of medical table top 2 may be chosen with sound engineering and/or medical judgment. The medical table top 2 may be constructed from a rigid inner core 9 material and an outer skin 8. The core material 9 may be a limited-energy ray absorbing foam that does not appreciably absorb examining energy rays, which may be X-rays, gamma rays and the like. The outer skin 8 may be constructed from carbon fiber. It is noted that any material may be chosen for the core material 9 and the outer skin 8 that does not substantially affect the examining energy rays.

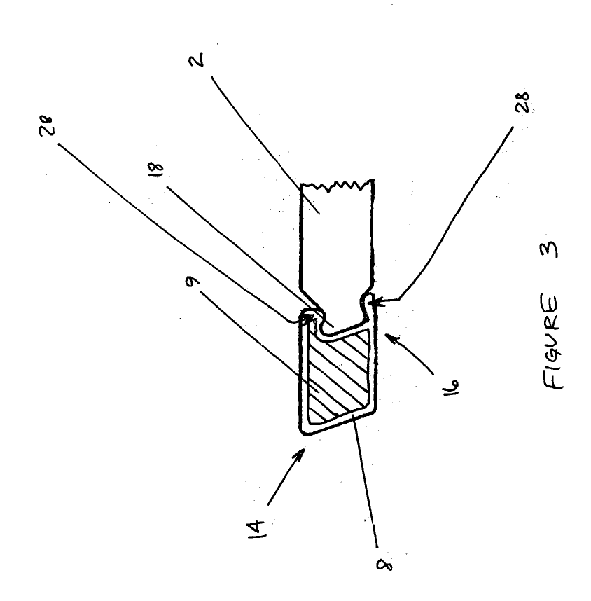

With continued reference to FIGS. 2a and 2b and now to FIG. 3, a medical table top extension 14 or an accessory extension 14 is shown attached to the medical table top 2. The medical table top extension 14 may be selectively attached to the medical table top 2 without the use of fasteners such as clamps, screws and the like. The medical table top extension 14 or accessory extension 14 may include a recess 16. Correspondingly, the medical table 2 may include a protrusion 18 or connecting portion 18 for use in interlocking with the recess 16 of the accessory extension 14. In this way, the recess 16 or female receiving portion 16 interlocks with the connecting portion 18 or male connecting portion 18 of the medical table top 2. The manner in which the accessory extension 14 interlocks with the medical table top 2 will be discussed later in another paragraph. The medical table top 2 may include a peripheral edge 21 traversing the circumference of the length and width of the medical table top 2. The male connecting portion 18 may be contiguously fashioned about the entire peripheral edge 21 of the medical table top 2. In this manner, the female receiving portion 16 may be selectively received onto the male connecting portion 18 at any point along the peripheral edge 21. This makes the accessory extension 14 extremely versatile and easily positionable at any place conducive to the medical practitioner's job in performing their diagnosis or treatment. In one embodiment, the accessory extension 14 is table top extension, shown in FIG. 2a, which increases the width of the table top. One or both sides of the medical table top 2 may be extended as desired for accommodating different size patients and patients having different medical needs. In another embodiment, the accessory extension 14 may include an arm extension 25 that connects to the connecting portion 18 taking up less width along the peripheral edge, shown in FIG. 1. It can be clearly seen that the any accessory extension can be constructed according to varied medical needs for interlocking onto the medical table top 2 as chosen with sound engineering and medical judgment. In this manner, the accessory extension 14 may be selectively infinitely positionable along the entire peripheral edge of the medical table top 2.

With reference to FIG. 3, the composition of the accessory extension 14 will now be discussed. The accessory extension 14 may include a core material 9 surrounded by an outer skin 8. The core material 9 may be foam that forms a rigid base of the accessory extension 14. However, any material may be used to form the rigid base of the accessory extension 14 as chosen with sound engineering judgment and that does not appreciably absorb examining energy rays. The outer skin 8 may be constructed of carbon fiber forming a laminate layer over the rigid base material. However, any material may be chosen for use as an outer skin material and any means of affixing the two sections together may be chosen with sound engineering judgment. In this way, the accessory extension 14 may be selectively positioned anywhere about the peripheral edge of the medical table top without interfering with examining energy rays during the medical procedure, treatment or diagnosis.

The receiving portion 16 of the accessory extension 14 and the connecting portion 18 of the medical table top 2 may be configured such that the two portions fit together with a snap fit. By snap fit it is meant that ends of receiving portion 16 of the accessory extension 14 may have a slightly smaller receiving portion opening with respect to the connecting portion protrusion. Subsequently, the receiving portion 16 may be resiliently deformable, which means that it can expand during installation and return to its original configuration without being permanently deformed. In other words, the receiving portion snaps onto the connecting portion and is held in place by the memory of the material which comprises the accessory extension 14. Additionally, the connecting portion 18 may have recessed areas 28 around which the receiving portion grips onto during usage. The end of the connecting portion 18 may also be slanted. However, any configuration of connecting portion 18 and receiving portion 16 may be chosen with sound engineering and/or medical judgment as is appropriate holding the accessory extension 14 in place. In this manner, the receiving portion 16 of the accessory extension 14 interlocks with the connecting portion 18 of the medical table top 2.

With reference to all of the Figures, operation of the invention will now be discussed. An associated operator may grasp the appropriate accessory extension 14 needed for a specific application prior to and/or during a medical procedure. The operator may select where it is best desired to position the accessory extension 14 along the peripheral edge of the medical table top. The operator may then angle the accessory extension 14 upward to fit the receiving portion over the connecting portion of the medical table top. Then the operator may press downward when the top portion of the receiving portion is juxtaposed to the recess of the connecting portion. A relatively small predetermined amount of force may be needed to overcome the resiliently deformable material of the accessory extension 14. Subsequently, the receiving portion is snapped onto the connecting portion. For disassembly, the operator may simply lift up on the accessory extension 14 overcoming the force of the resiliently deformable material and remove the accessory extension 14.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. (cancelled)

2. (cancelled)

3. (cancelled)

4. (cancelled)

5. (cancelled)

6. (cancelled)

7. A medical device, comprising:
a medical procedural table top having a peripheral edge, the peripheral edge having a connecting portion;
at least a first medical table top extension having a receiving portion, wherein the receiving portion is adapted to interlock with the connecting portion;
wherein the at least a first medical table top extension does not substantially absorb associated examining energy rays;
wherein the medical table top extension is selectively infinitely positionable along the peripheral edge.

8. The at least a first medical device of claim 7, wherein the medical procedural table top does not substantially absorb associated examining energy rays.

9. The at least a first medical device of claim 8, wherein the medical table top extension is comprised of carbon fiber.

10. The at least a first medical device of claim 9, wherein the medical table top extension is comprised of:
a rigid core; and,
a skin portion, wherein the skin portion is constructed of carbon fiber.

11. The medical device of claim 10, wherein the connecting portion includes a male connecting portion, and,
wherein the at least a first medical table top extension includes a female receiving portion for use in interlocking with the male connecting portion.

12. (Cancelled)

13. The at least a first medical device of claim 12, wherein the medical table top extension is an arm extension.

14. The at least a first medical device of claim 13, wherein the medical table top extension is a catheter support extension.

15. The at least a first medical device of claim 7, wherein the medical procedural table top is a medical surgical table top.

16. The medical device of claim 7, wherein the connecting portion substantially traverses the length of the peripheral edge.
